(19) United States
(12) Patent Application Publication
(10) Pub. No.: US 2012/0087356 A1
(43) Pub. Date: Apr. 12, 2012

(54) TUNNELED DIRECT LINK SETUP THROUGH A TUNNEL

(75) Inventor: Maarten Menzo Wentink, Naarden (NL)

(73) Assignee: QUALCOMM, Incorporated, San Diego, CA (US)

(21) Appl. No.: 12/899,702

(22) Filed: Oct. 7, 2010

(51) Int. Cl. H04W 8/22

(52) U.S. Cl. 370/338

(57) ABSTRACT

One feature provides for a first station initiating a Tunnel Direct Link Setup (TDLS) link with a peer station within a network, by establishing a tunnel with the peer station, and establishing the TDLS link with the second station through the tunnel. The TDLS link may be implemented within the same layer of a protocol stack as the tunnel. Moreover, the network may comprise at least one access point that serves as an intermediary for transmissions between the first station and the peer station. Although the access point may be adapted to block Ethernet encapsulated TDLS frame transmissions having a TDLS Ethertype between the first station and the peer station, the first and peer stations are able to establish a TDLS link by transmitting and receiving TDLS Setup information through the tunnel by encapsulating the TDLS Setup information with, for example, PPP, PPTP, and/or L2TP tunnel schemes.

### BACKGROUND

1. Field

One feature generally relates to establishing a tunneled direct link setup between two stations through a legacy access point by first establishing a tunnel between the two stations.

2. Background

The increased availability of wireless local area networks (WLANs) has allowed stations, such as desktop computers, laptop computers, hand held PDAs, and mobile phones, to wirelessly connect with one another through a variety of networks, such as local area networks (LANs) and the Internet. For example, a user can take her laptop computer from her desk into a conference room to attend a meeting and still have access to her local network to retrieve data and have access to the Internet via one or more modems or gateways present on the local network without being tethered by a wired connection. Similarly, a user of a desktop computer may connect to a network, such as a LAN and the Internet, without having a wired connection to a modem or gateway present on the local network.

A WLAN may be comprised of four primary components. These components may include stations (STAs), access points (APs), a wireless medium and a distribution system. The network is built to transfer data between STAs that may include computing devices with wireless network interfaces. For example, laptop computers, desktop computers, mobile phones, and other electronic devices have wireless network interfaces are examples of stations within a network. APs are devices that allow STAs to connect to one another and transfer data. Examples of APs include routers, centralized controllers, a base stations, node Bs, or site controllers.

IEEE 802.11 is a set of standards associated with WLAN computer communication in the 2.4, 3.6 and 5 GHz frequency bands. In IEEE 802.11, a basic service set (BSS) is the basic building block of an 802.11 WLAN, that comprises at least one AP and at least one STA. A simple BSS may comprise a self-contained network with one AP that interconnects one or more STAs with one another and may not have connectivity with other BSSs or networks. By contrast, an extended BSS is a set of one or more interconnected BSSs and integrated LANs that appear as a single BSS to the logical link control layer at any STA associated with one of those BSSs.

Some legacy extended BSSs may require data transmitted between stations to pass through an AP without permitting the direct transmission of data between STAs. However, in recent years a direct link setup (DLS) between the STAs has been established to improve the efficiency of a wireless network. Accordingly, a BSS that supports DLS includes APs and STAs that support DLS thereby allowing STAs to setup direct links and directly communicate with each other over the direct links.

However, in most WLAN environments currently used (for example, WLAN environments in accordance with the IEEE 802.11a/b), STAs may support DLS while the APs may not. Such APs that do not support DLS are herein referred to as legacy APs. As a result, STAs equipped to handle DLS within a BSS having legacy APs may not be able to engage in such direct communication.

A Tunneled Direct Link Setup (TDLS) is a wireless communication protocol newly suggested to overcome such a limitation in BSSs featuring legacy APs. TDLS allows STAs to set up direct links with one another in networks having legacy APs by tunneling TDLS Setup frames/messages through the AP. Accordingly, the TDLS defines procedures for allowing STAs to set up a direct link in a BSS having legacy APs. Hereinafter, a wireless network supporting the TDLS procedure is referred to as a TDLS wireless network.

An STA wishing to setup (or disconnect) a TDLS link with another STA (referred to also as “peer STA”) may transmit encapsulated TDLS management action frames to the peer STA through the legacy AP.

For example, a TDLS management frame may be encapsulated in an Ethernet frame (e.g., in the data/payload portion of the frame) and sent to the legacy AP from the STA wishing to setup the TDLS link. The legacy AP understands how to read and forward Ethernet frames, and thus passes the frame on until it reaches the peer STA.

However, some legacy APs do not accept TDLS frames encapsulated by an Ethernet frame. In other words, some legacy APs filter out Ethernet frames carrying TDLS frames as data. In BSSs having such filtering legacy APs, STAs may not be able to create TDLS links with peer STAs and therefore the network may not be able to communicate as efficiently as possible.

Therefore, there is a need for systems, devices, and methods that override such problems and allow for the transmission of TDLS Setup information from one STA to a peer STA in BSSs having legacy APs that filter data frames containing TDLS management frames. Embodiments are disclosed herein that allow for a TDLS link to be established between STAs, even in BSSs having APs that filter data frames, such as Ethernet frames, carrying TDLS management frames.

### SUMMARY

One feature provides for a method operational at a first station (a first station, and/or a processor-readable medium having one or more instructions operational on a first station) to initiate a Tunneled Direct Link Setup (TDLS) link within a network, comprises: establishing a tunnel with a second station; and establishing the TDLS link with the second station through the tunnel In one embodiment, the TDLS link may be implemented within the same layer of a protocol stack as the tunnel In one embodiment, the network comprises at least one access point that serves as an intermediary for transmissions between the first station and the second station. In another embodiment, although the access point may be adapted to block Ethernet encapsulated TDLS frame transmissions having a TDLS Ethertype between the first station and the peer station, the first and peer stations are able to establish a TDLS link by transmitting and receiving TDLS Setup information through the tunnel by encapsulating the TDLS Setup information with, for example, PPP, PPTP, and/or L2TP tunnel schemes.

In one embodiment, establishing the TDLS link through the tunnel further includes: transmitting TDLS Setup Request information to the second station through the tunnel; receiving TDLS Setup Response information from the second station through the tunnel; and transmitting TDLS Setup Confirm information to the second station through the tunnel. In another embodiment, the tunnel includes an encryption protocol that encrypts the TDLS Setup Request information, the TDLS Setup Response information, and the TDLS Setup Confirm information. In another embodiment, the method further comprises: encrypting the TDLS Setup Request information with a private key; decrypting the TDLS Setup Response information with a public key; and encrypting the TDLS Setup Confirm information with the private key.

In one embodiment, the tunnel is established using at least one of a Point-to-Point Protocol (PPP), a Point-to-Point Tunneling Protocol (PPTP), or a Layer 2 Tunneling Protocol (L2TP). In another embodiment, the tunnel is established using a Point-to-Point Protocol (PPP), and establishing the TDLS link through the tunnel further includes: encapsulating TDLS Setup Request information within a first PPP packet prior to transmitting the TDLS Setup Request information to the second station; receiving TDLS Setup Response information that is encapsulated within a second PPP packet from the second station; and encapsulating TDLS Setup Confirm information within a third PPP packet prior to transmission to the second station.

In another embodiment, the tunnel is established using a Point-to-Point Tunneling Protocol (PPTP), and establishing the TDLS link through the tunnel further includes: encapsulating TDLS Setup Request information within a first Point-to-Point Protocol (PPP) packet and a first General Routing Encryption (GRE) packet prior to transmitting the TDLS Setup Request information to the second station; receiving TDLS Setup Response information that is encapsulated within a second PPP packet and a second GRE packet from the second station; and encapsulating TDLS Setup Confirm information within a third PPP packet and a third GRE packet prior to transmission to the second station. In yet another embodiment, the tunnel is established using L2TP, the method further comprises: encapsulating TDLS Setup Request information within a first L2TP packet prior to transmitting the TDLS Setup Request information to the second station; receiving TDLS Setup Response information that is encapsulated within a second L2TP packet from the second station; and encapsulating TDLS Setup Confirm information within a third L2TP packet prior to transmission to the second station.

Another feature provides for a method operational at a second station (a second station, and/or a processor-readable medium having one or more instructions operational on a second station) within a network for establishing a Tunneled Direct Link Setup (TDLS) link initiated by a first station, comprises: establishing a tunnel with the first station; and establishing the TDLS link with the first station through the tunnel In one embodiment, the TDLS link is implemented within the same layer of a protocol stack as the tunnel In another embodiment, the network includes an access point that serves as an intermediary for transmissions between the first station and the second station. In yet another embodiment, although the access point may be adapted to block Ethernet encapsulated TDLS frame transmissions having a TDLS Ethertype between the first station and the peer station, the first and peer stations are able to establish a TDLS link by transmitting and receiving TDLS Setup information through the tunnel by encapsulating the TDLS Setup information with, for example, PPP, PPTP, and/or L2TP tunnel schemes.

In one embodiment, the method operational at a second station further comprises: receiving TDLS Setup Request information from the first station through the tunnel; transmitting TDLS Setup Response information to the first station through the tunnel; and receiving TDLS Setup Confirm information from the first station through the tunnel In another embodiment, the tunnel includes an encryption protocol that encrypts the TDLS Setup Request information, the TDLS Setup Response information, and the TDLS Setup Confirm information. In another embodiment, the method further comprises: decrypting the TDLS Setup Request information with a private key; encrypting the TDLS Setup Response information with a public key; and decrypting the TDLS Setup Confirm information with the private key. In yet another embodiment, the tunnel is established using at least one of a Point-to-Point Protocol (PPP), a Point-to-Point Tunneling Protocol (PPTP), or a Layer 2 Tunneling Protocol (L2TP). In yet another embodiment, the tunnel is established using a Point-to-Point Protocol (PPP), and establishing the TDLS link with the first station through the tunnel includes: receiving TDLS Setup Request information that is encapsulated within a first PPP packet from the first station; encapsulating TDLS Setup Response information within a second PPP packet prior to transmitting the TDLS Setup Response information to the first station; and receiving TDLS Setup Confirm information that is encapsulated within a third PPP packet from the first station.

In another embodiment, the tunnel is established using a Point-to-Point Tunneling Protocol (PPTP), and establishing the TDLS link with the first station through the tunnel includes: receiving TDLS Setup Request information that is encapsulated within a first PPP packet and a first General Routing Encapsulation (GRE) packet from the first station; encapsulating TDLS Setup Response information within a second PPP packet and a second GRE packet prior to transmitting the TDLS Setup Response information to the first station; and receiving TDLS Setup Confirm information that is encapsulated within a third PPP packet and a third GRE packet from the first station. In yet another embodiment, the tunnel is established using a Layer 2 Tunneling Protocol (L2TP), and establishing the TDLS link with the first station through the tunnel includes: receiving TDLS Setup Request information that is encapsulated within a first L2TP packet from the first station; encapsulating TDLS Setup Response information within a second L2TP packet prior to transmitting the TDLS Setup Response information to the first station; and receiving TDLS Setup Confirm information that is encapsulated within a third L2TP packet from the first station.

### BRIEF DESCRIPTION OF THE DRAWINGS

FIG. 1 illustrates one example of an Open Systems Interconnection (OSI) model illustrated by seven layers.

FIG. 2 illustrates a functional block diagram of a basic service set (BSS) comprising two stations interconnected through a legacy access point (AP).

FIG. 3 illustrates one example of the fields that comprise a Tunneled Direct Link Setup (TDLS) frame body.

FIG. 4 illustrates Tunneled Direct Link Setup (TDLS) frame types and corresponding values.

FIG. 5 illustrates one example of the fields that comprise an Ethernet frame.

FIG. 6 illustrates a Tunneled Direct Link Setup (TDLS) frame body encapsulated within an Ethernet frame.

FIG. 7 shows a flowchart illustrating an exemplary method of establishing a TDLS link between two stations within a basic service set (BSS) having legacy access points (APs).

FIG. 8 illustrates a Tunneled Direct Link Setup (TDLS) frame body encapsulated by a Layer 2 Tunneling Protocol packet.

FIG. 9 illustrates a Tunneled Direct Link Setup (TDLS) frame body encapsulated by a Point-to-Point Protocol (PPP) packet.

FIG. 10 illustrates a Tunneled Direct Link Setup (TDLS) frame body encapsulated with a Point-to-Point Tunneling Protocol (PPTP) scheme.

FIG. 11 illustrates a functional block diagram of an initiating station.

FIG. 12 shows a flowchart illustrating an exemplary method operational at the initiating station to establish a TDLS link with the peer station within a BSS having legacy APs.

FIG. 13 illustrates a functional block diagram of a peer station according to one embodiment.

FIG. 14 shows a flowchart illustrating an exemplary method operational at the peer station to establish a Tunneled Direct Link Setup (TDLS) link with the initiating station within a basic service set (BSS) having legacy access points (APs).

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may not be shown in detail in order not to obscure the embodiments.

In the following description, certain terminology is used to describe certain features of one or more embodiments. For instance, the term “station” includes, but is not limited to, a laptop computer, a desktop computer, a server, a wireless device, a mobile phone, a mobile communication device, a user communication device, a personal digital assistant, and/or other types of devices having some form of communication capabilities (e.g., wired, wireless, infrared, short-range radio, etc.). The term “initiating station” refers to a station that initiates a TDLS link with another station. The term “peer station” refers to a station that facilitates, accepts, and/or responds to an initiating station's request to establish a TDLS link.

### Overview

Techniques utilizing tunneling are presented herein to allow for a TDLS link to be established between two stations within a BSS having legacy APs that filter out or otherwise do not accept TDLS frames encapsulated by data frames, such as Ethernet frames.

In one embodiment, TDLS frames are encapsulated by, for example, Layer 2 Tunneling Protocol (L2TP) packets before being transmitted to the legacy AP. In other embodiments, the TDLS frames are encapsulated by Point-to-Point Protocol (PPP) packets before being transmitted to the legacy AP. In yet other embodiments, the TDLS frames are encapsulated within a Point-to-Point Tunneling Protocol scheme. Accordingly, a legacy AP that filters out TDLS Setup information encapsulated with an Ethernet frame having a TDLS Ethertype, will not be able to detect the presence of TDLS Setup information since it is encapsulated in a tunneling scheme.

### Exemplary Network Environment

Most wireless communication networks, including WLANs, may be broken down into different sections in order to help conceptualize the inner workings and structure of the network. For example, the Open Systems Interconnection model (OSI model) is a way of sub-dividing a communications system into smaller parts called layers. A “layer” is a collection of conceptually similar functions that provide services to the layer above it and receives services from the layer below it. On each layer an instance provides services to the instances at the layer above and requests service from the layer below. Embodiments presented herein for establishing a TDLS link through a tunnel may be implemented and conceptualized within such a scheme.

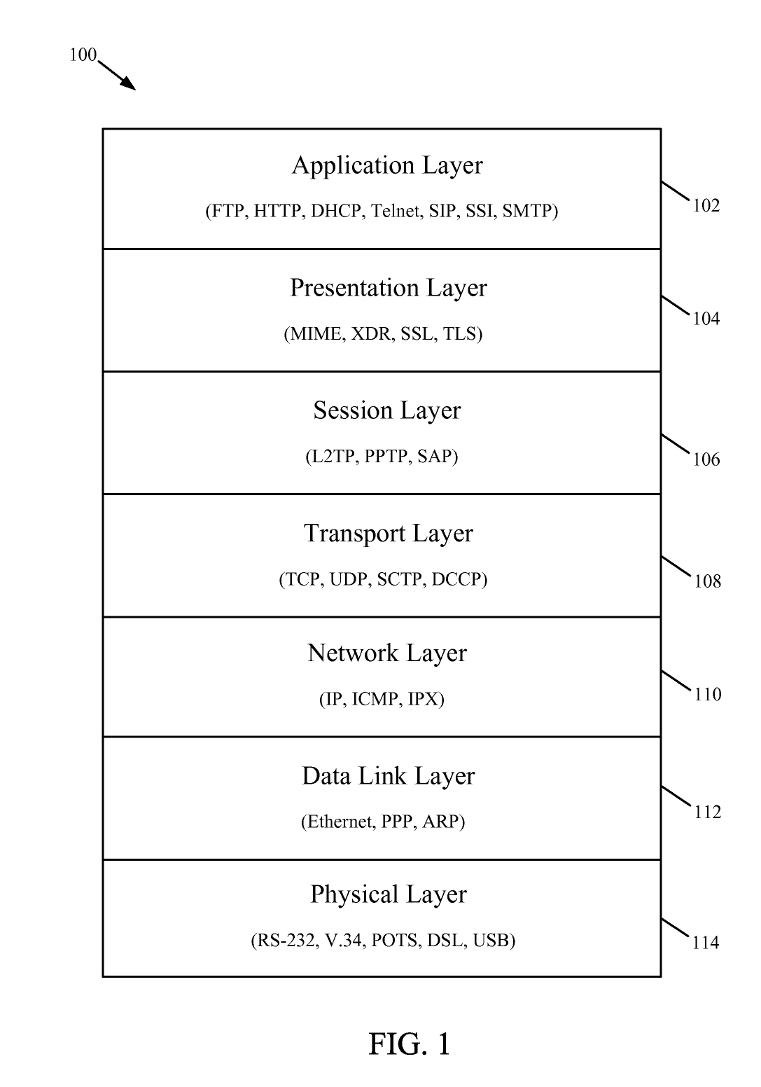

FIG. 1 illustrates one example of an OSI model 100 illustrated by seven layers ranging from “highest” (i.e., conceptually closer to the user) to “lowest” (i.e., bottom level mechanics less noticeable to the user). The OSI model may comprise an Application layer 102 at the top, followed by a Presentation layer 104, Session layer 106, Transport layer 108, Network layer 110, Data Link layer 112, and a Physical layer 114.

The Application layer 102 is the OSI layer closest to the end user, which means that both the OSI application layer and the user interact directly with the software application. This layer 102 interacts with software applications that implement a communicating component. Application layer 102 functions typically include identifying communication partners, determining resource availability, and synchronizing communication. Some examples of application layer 102 implementations include Hypertext Transfer Protocol (HTTP), File Transfer Protocol (FTP), Simple Mail Transfer Protocol (SMTP), and X.400 Mail.

The Presentation layer 104 establishes context between Application layer entities, in which the higher-layer entities may use different syntax and semantics if the presentation service provides a mapping between them. This layer 104 provides independence from data representation (e.g., encryption) by translating between application and network formats. The Presentation layer 104 transforms data into the form that the application accepts.

The Session layer 106 controls the connections between computers. It establishes, manages and terminates the connections between the local and remote application. It provides for full-duplex, half-duplex, or simplex operation, and establishes check-pointing, adjournment, termination, and restart procedures. Examples of Session layer 106 implementations include Layer 2 Tunneling Protocol (L2TP), and Point-to-Point Tunneling Protocol (PPTP).

The Transport layer 108 provides for the transparent transfer of data between end users, providing reliable data transfer services to the upper layers. The Transport layer 108 controls the reliability of a given link through flow control, segmentation, desegmentation, and error control. This layer 108 may also keep track of the segments and retransmit those that fail, and provide acknowledgement of successful data transmission. Examples of Transport layer 108 implementations include Transmission Control Protocol (TCP), and User Datagram Protocol (UDP).

The Network layer 110 provides the functional and procedural means of transferring variable length data sequences from a source to a destination via one or more networks, while maintaining the quality of service requested by the Transport layer 108. The Network layer 110 performs network routing functions, and might also perform fragmentation and reassembly, and report delivery errors. Routers operate at this layer—sending data throughout the extended network and making the Internet possible. Examples of Network layer 110 implementations may include Internet Protocol (IP), and Internet Control Message Protocol (ICMP).

The Data Link layer 112 is the protocol layer which transfers data between adjacent network nodes in a wide area network or between nodes on the same local area network segment. The Data Link layer 112 provides the functional and procedural means to transfer data between network entities and might provide the means to detect and possibly correct errors that may occur in the Physical layer 114. This layer 114 is concerned with local delivery of frames between devices on the same LAN. Examples of data link protocols are Ethernet for local area networks (multi-node), and the Point-to-Point Protocol (PPP).

The Physical layer 114 defines the electrical and physical specifications for devices. In particular, it defines the relationship between a device and a transmission medium, such as a copper or optical cable. This includes the layout of pins, voltages, cable specifications, hubs, repeaters, network adapters, host bus adapters, etc.

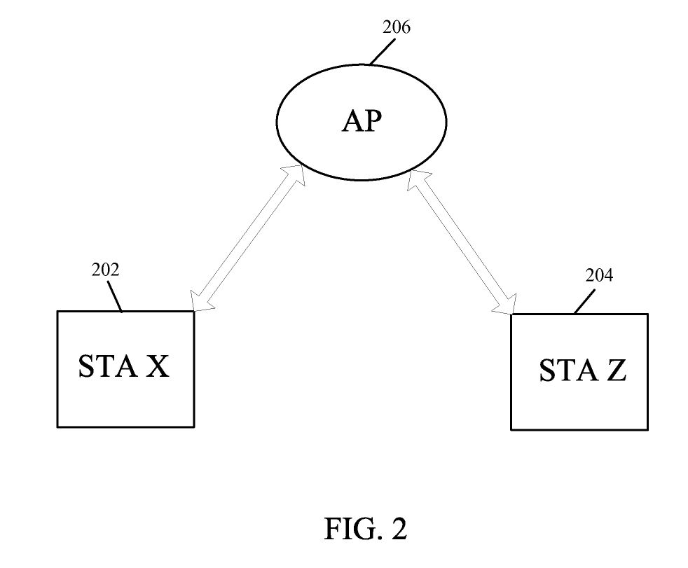

FIG. 2 illustrates a functional block diagram of a basic service set (BSS) comprising two stations, STA X 202 and STA Z 204, interconnected through a legacy AP 206. STA X 202 and STA Z 204 may be laptops, mobile phones, desktop computers, etc., and may be connected to the legacy AP 206 through a wireless or wired connection. The two stations 202, 204 may desire to setup a TDLS link with each other through the legacy AP 206. As discussed in part above, a TDLS link allows for a direct tunnel connection between two or more STAs within a BSS having legacy APs. In order to establish a TDLS link between the stations 202, 204, TDLS Setup frames may be transmitted between the stations 202, 204 via the AP 206.

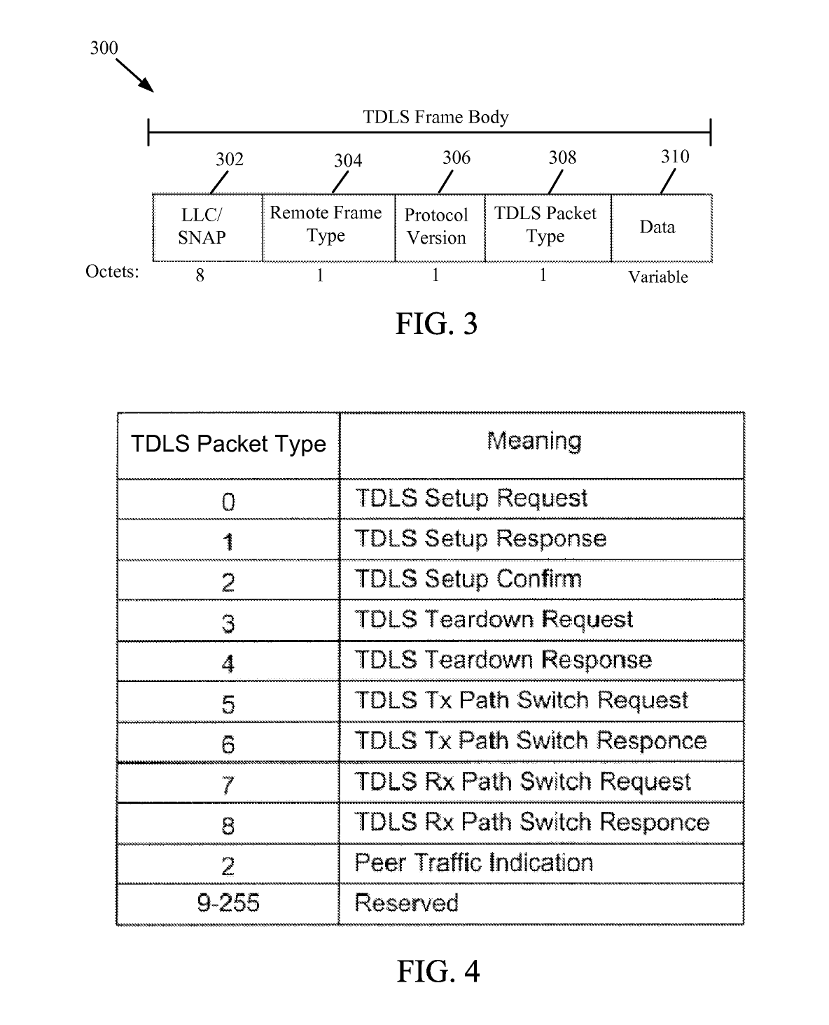

FIG. 3 illustrates one example of the fields that comprise a TDLS frame body 300 (Ethernet frame encapsulation removed). The TDLS frame 300 may comprise a logical link control (LLC)/sub-network access protocol (SNAP) header 302, a remote frame type 304, protocol version 306, a TDLS packet type 308, and data 310 (i.e., paypload). The TDLS packet type 308 field may be set to a value for specifying the type of TDLS frame. Examples of the types of TDLS frames and their corresponding values are shown in FIG. 4. For example, the TDLS frame may be a Setup Request frame, a Setup Response frame, a Setup Confirm frame, a Teardown Request frame, a Teardown Response frame, etc. TDLS Setup frames (also referred herein as “TDLS Setup information”) may include TDLS Setup Request frames, TDLS Setup Response frames, and TDLS Setup Confirm frames.

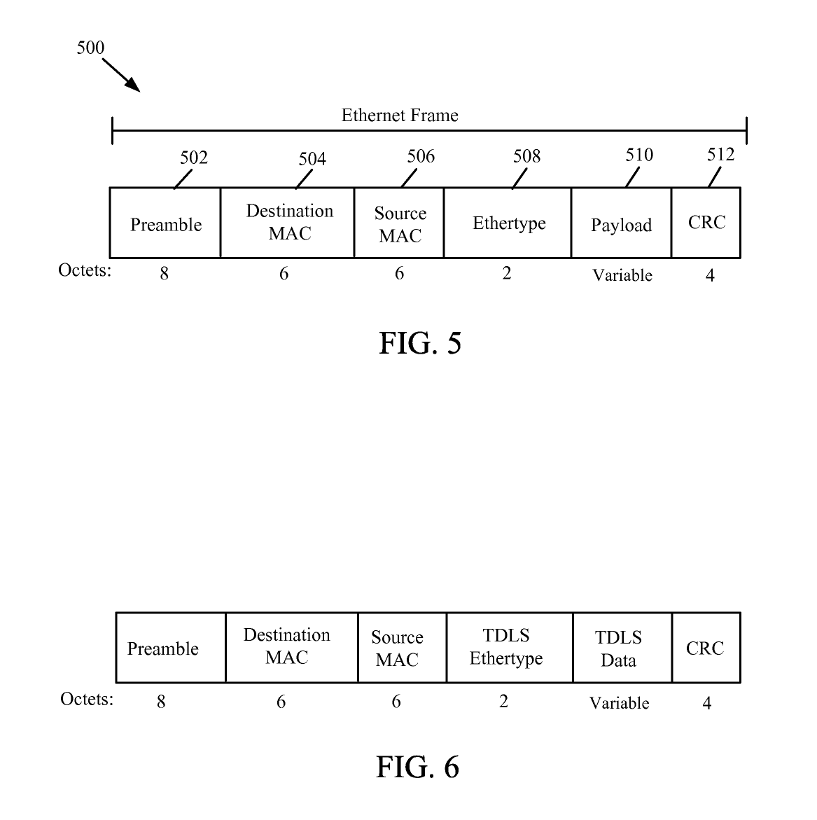

TDLS frames transmitted between the stations 202, 204 are encapsulated as data frames prior to transmission because legacy APs do not support DLS. For example, the aforementioned TDLS frame body may be encapsulated in an Ethernet frame. FIG. 5 illustrates one example of the fields that comprise an Ethernet frame 500. An Ethernet frame 500 may comprise a preamble 502, a destination MAC address 504, a source MAC address 506, an Ethertype 508, payload (i.e., data) 510, and a cyclic redundancy check field (CRC) 512. The Ethertype 508 field is a two-octet field used to indicate which protocol is encapsulated in the payload 510 of the Ethernet frame 500. For example, Ethertype “890d” (hexadecimal representation) represents a TDLS frame indicating that the payload of the Ethernet frame may contain TDLS data. FIG. 6 illustrates a TDLS frame body encapsulated within an Ethernet frame. Thus, an Ethernet frame may encapsulate the various types of TDLS frames shown in FIG. 4.

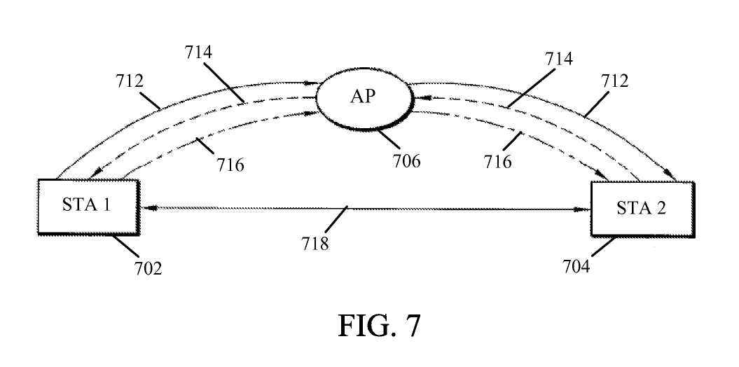

FIG. 7 shows a flowchart illustrating an exemplary method of establishing a TDLS link between two stations within a BSS having legacy APs. The method involves a three-way handshake process using the legacy AP as an intermediary. Initially, STA X 702 (also referred to herein as an “initiating station,” “initiating first station,” and/or a “first station”) transmits a TDLS Setup Request frame 712 to STA Z 704 (also referred to herein as a “peer station” and/or “second station”) via the legacy AP 706. Once received, STA Z 704 transmits a TDLS Setup Response frame 714 back to STA X via the AP 706. The TDLS Setup Response frame 714 causes STA X 702 to transmit a TDLS Setup Confirm 716, which upon receipt by STA Z 704, establishes the tunneled direct link. Accordingly, the legacy AP 706 performs the function of relaying TDLS Setup information between the stations 702, 704 that establishes the TDLS link 718.

However, some legacy APs do not allow TDLS frames encapsulated by Ethernet frames from being transmitted from STA X 702 to STA Z 704. That is, the legacy AP 706 may filter out Ethernet frames it receives that have the TDLS Ethertype “890d.”

To circumvent this problem, presented herein are embodiments that allow stations, such as STA X 702 and STA Z 704, to still establish a tunneled direct link despite such legacy APs that filter out Ethernet frames encapsulating TDLS Setup information. In some embodiments, a tunnel may first be established between the stations to transmit the TDLS frames and thereby establish a TDLS link within the tunnel In some embodiments, the tunnel may act as a “layer 2 tunnel,” such as Layer 2 Tunneling Protocol and/or Point-to-Point Tunneling Protocol. In other embodiments, the TDLS link may be implemented within the same layer of a protocol stack of the tunnel (e.g., layer 2 tunnel). In some embodiments the tunnel may be a Point-to-Point Protocol tunnel. In yet other embodiments, the tunnel may include security/encryption protocols that secure the data transmitted between the STAs 702, 704.

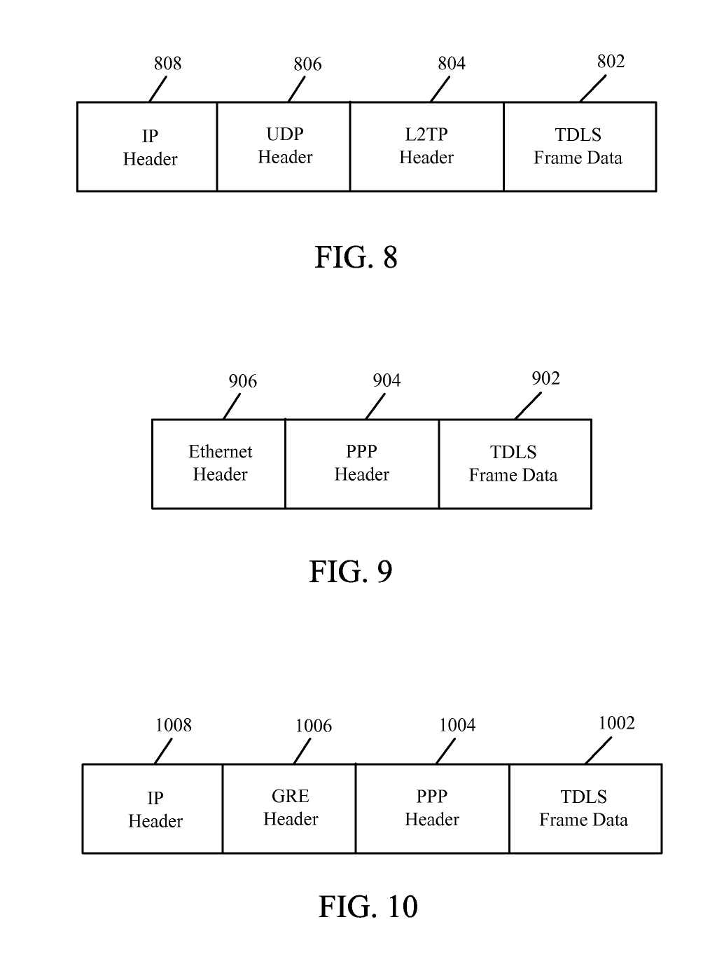

FIG. 8 illustrates a TDLS frame body 802 encapsulated by a Layer 2 Tunneling Protocol packet 804 according to one embodiment. Layer 2 Tunneling Protocol (L2TP) is a tunneling protocol that acts like a Data Link layer protocol, but in fact is a Session layer protocol. Thus, the Layer 2 Tunneling Protocol packet is encapsulated by a UDP frame 806 which is in turn encapsulated by an IP frame 808 (corresponding frame trailers have been omitted for clarity for FIGS. 8-10). Computer networks use a tunneling protocol when one network protocol (the delivery protocol) encapsulates a different payload protocol. By using tunneling one can, for example, carry a payload over an incompatible delivery-network, or provide a secure path through an untrusted network.

By encapsulating the TDLS frame data 802 within a Layer 2 Tunneling Protocol packet 804, the legacy AP 706 will not be able to filter out the TDLS frame data based 802 on a TDLS Ethertype. TDLS frame data 802 includes TDLS Setup information. Thus, STA X 702 may transmit a TDLS Setup Request frame encapsulated within a Layer 2 Tunneling Protocol packet without the legacy AP 706 being able to detect the TDLS frame data. Similarly, STA X 702 may receive a Setup Response frame from STA Z, and transmit a Setup Confirm frame to STA Z that are all also encapsulated by L2TP packets.

FIG. 9 illustrates a TDLS frame body 902 encapsulated by a Point-to-Point Protocol (PPP) packet 904 according to one embodiment. The PPP is a data link protocol used in establishing a direct connection between two networking nodes. It can provide connection authentication, transmission encryption privacy, and compression. In FIG. 9, the PPP packet 904 is encapsulated by an Ethernet frame, which is commonly known as Point-to-Point over Ethernet, or PPPoE. In other embodiments, other Data Link layers, such as Asynchronous Transfer Mode (ATM), may be used to encapsulate the PPP packet.

By encapsulating the TDLS frame data 902 within a PPP packet 904, the legacy AP 706 will not be able to filter out the TDLS frame data based on a TDLS Ethertype. Thus, STA X 702 may transmit a TDLS Setup Request frame encapsulated within a PPP packet without the legacy AP 706 being able to detect the TDLS frame data. Similarly, STA X 702 may receive a TDLS Setup Response frame from STA Z, and transmit a TDLS Setup Confirm frame to STA Z that are all also encapsulated by PPP packets.

FIG. 10 illustrates a TDLS frame body 902 encapsulated with a Point-to-Point Tunneling Protocol (PPTP) scheme according to one embodiment. The PPTP is a tunneling protocol that may use a control channel over TCP and a General Routing Encapsulation (GRE) tunnel that operates to encapsulate PPP packets. GRE tunnels are designed to be completely stateless. That is, each tunnel end-point does not keep any information about the state or availability of the remote tunnel end-point. A consequence of this is that the local tunnel end-point router does not have the ability to bring the line protocol of the GRE tunnel interface down if the remote end-point is unreachable.

FIG. 10 illustrates how the TDLS frame data 1002 is encapsulated by a PPP packet 1004, similar to that shown in FIG. 9. However, in PPTP the PPP packet 1004 is further encapsulated by a GRE frame 1006, which is in turn further encapsulated, for example, by an IP frame 1008. By encapsulating the TDLS frame data 902 within the PPTP scheme, the legacy AP 706 will not be able to filter out the TDLS frame data based on a TDLS Ethertype. Thus, STA X 702 may transmit a TDLS Setup Request frame encapsulated within a PPTP scheme without the legacy AP 706 being able to detect the TDLS frame data. Similarly, STA X 702 may receive a TDLS Setup Response frame from STA Z, and transmit a TDLS Setup Confirm frame to STA Z that are all also encapsulated by PPP packets within a PPTP scheme.

In other embodiments, any tunneling scheme may be used besides the aforementioned protocols. Any tunneling protocol that acts to encapsulating the TDLS frame data and hide the TDLS frame data from the legacy AP by hiding or eliminating the TDLS Ethertype is within the scope of the application.

### Security

In some embodiments, security may be added to the tunneling schemes (L2TP PPTP, and/or PPP) presented herein to further hide and protect the TDLS identity of the tunneled payload. For example, by encrypting the TDLS frame data, a legacy AP that looks within the tunneled frame will not be able to detect the presence of TDLS frame data. Thus, encryption will further help stations, such as STA X 702 and STA Z 704, to establish a TDLS link within a BSS having a legacy AP that filters such sessions.

Various security and encryption techniques may be applied to the tunneling schemes above as is known in the art. For example, Internet Protocol Security (IPsec) may be used in conjunction with L2TP. IPsec is a protocol suite for securing Internet Protocol (IP) communications by authenticating and encrypting each IP packet of a communication session. IPsec also includes protocols for establishing mutual authentication between agents at the beginning of the session and negotiation of cryptographic keys to be used during the session. IPsec is an end-to-end security scheme operating in the Network layer (Internet Layer of the Internet Protocol Suite). It can be used in protecting data flows between a pair of hosts (host-to-host), between a pair of security gateways (network-to-network), or between a security gateway and a host (network-to-host).

IPsec used with the tunneling schemes to hide the TDLS frame data may employ Internet Key Exchange (IKE), Authentication Headers (AH), and/or Encapsulating Security Payload (ESP) techniques. IKE may set up a security association by handling the negotiation of protocols and algorithms and by generating the encryption and authentication keys to be used by IPsec. AH may provide connectionless integrity and data origin authentication for IP datagrams and protection against replay attacks. ESP may provide confidentiality, data origin authentication, connectionless integrity, an anti-replay service, and limited traffic flow confidentiality.

Other Internet security systems may also be used, such as, Secure Sockets Layer (SSL), Transport Layer Security (TLS), and Secure Shell (SSH). These security protocols operate in the upper layers of the OSI and TCP/IP models. In other embodiments, for example with use in a PPTP embodiment scheme, Microsoft® Point-to-Point Encryption (MPPE) may be used. In other embodiments, Extensible Authentication Protocol Transport Layer Security (EAP-TLS) may be used. EAP-TLS uses a public key infrastructure to secure communication to a RADIUS authentication server or another type of authentication server.

Security schemes used may include public-private key pairs according to a public key infrastructure, and/or symmetric private keys. For example, the peer station 704 may obtain the public key of the initiating station 702 in order to encrypt messages transmitted from the peer station 704 to the initiating station 702. Similarly, the initiating station 702 may obtain the public key of the peer station 704 in order to encrypt messages transmitted from the initiating station 702 to the peer station 704. Each of the stations 702, 704 may then use their own respective private keys to decrypt the encrypted messages received. In other embodiments the stations 702, 704 may share a symmetric private key used to encrypt messages transmitted to each other.

### Exemplary Initiating Station

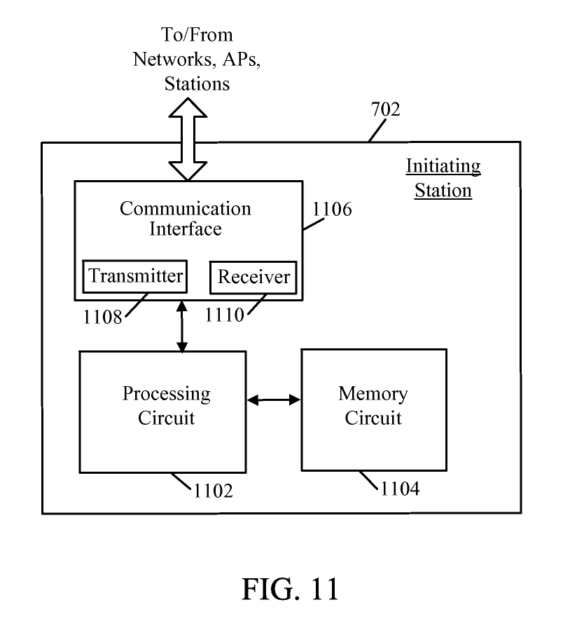

FIG. 11 illustrates a functional block diagram of an initiating station 702 according to one embodiment. The initiating station 702 may comprise a processing circuit 1102 (e.g., processor, processing module, etc.), a memory circuit 1104 (e.g., memory, memory modules, etc.), and a communications interface 1106. The communications interface 1106 may further comprise a transmitter 1108 and a receiver 1110.

The processing circuit 1102 is configured to process data, including TDLS frame data and perform any and all of the processing associated with preparing the TDLS frame data for transmission and reception, such as but not limited to, tunneling encapsulation and security encryption/decryption. The memory circuit 1104 is configured to store data including TDLS frame data, and encryption keys used for security schemes, such as private and public keys. The communication interface's 1106 transmitter 1108 is configured to transmit data to other network devices, such as APs and other stations. The communication interface's 1106 receiver 1110 is configured to receive data from other network devices, such as APs and other stations. Thus, the communication interface 1106 allows the initiating station 702 to transmit and receive TDLS frame data along with other forms of data. The communication interface 1106 may be wireless or wired.

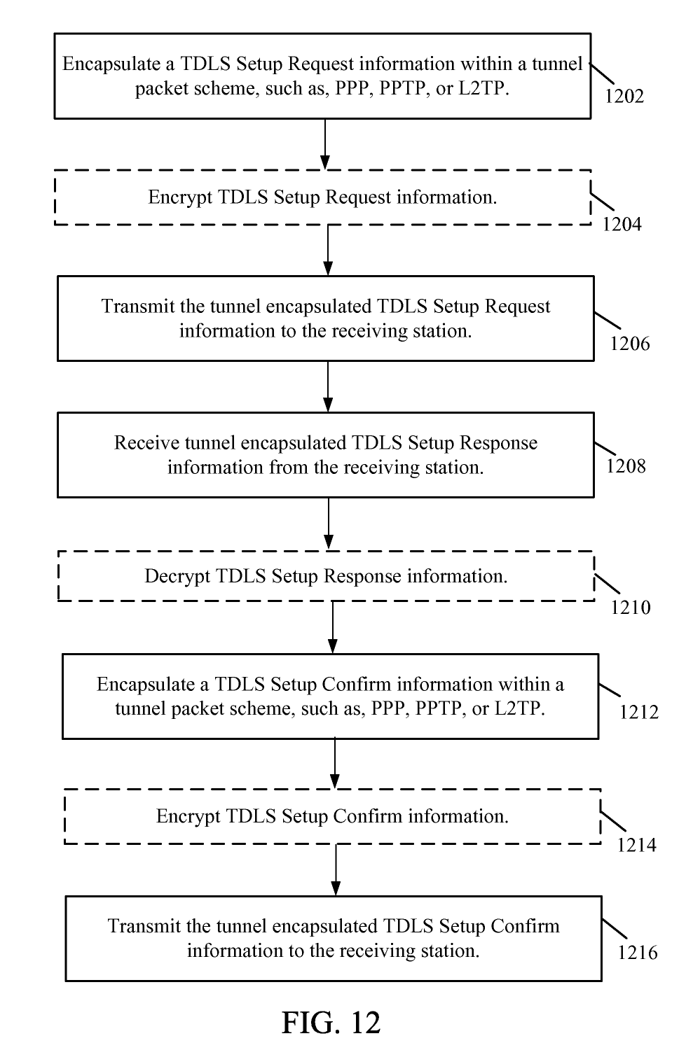

FIG. 12 shows a flowchart illustrating an exemplary method operational at the initiating station 702 to establish a TDLS link with the peer station 704 within a BSS having legacy APs. In step 1202, the initiating station 702 first encapsulates a TDLS Setup Request frame within a tunneling scheme as described above, such as but not limited to, PPP, PPTP, or L2TP (e.g., according to FIGS. 8-10). In step 1204, the initiating station 702 may then optionally add security to the link using any one of the aforementioned security protocols. For example, the initiating station may encrypt the TDLS Setup Request frame using, for example, a private key. In some embodiments, encryption of the TDLS frame occurs after encapsulation by an Ethernet, IP, PPP, GRE, and/or L2TP header/trailer, thereby encrypting the entire encapsulated frame. In other embodiments, only the TDLS frame itself is encrypted. Next, in step 1206, the initiating station 702 transmits the tunnel encapsulated TDLS Setup Request information to the peer station 704 with the legacy AP 706 acting as an intermediary.

In step 1208, the initiating station 702 may then receive TDLS Setup Response information encapsulated within a tunnel scheme as described above, such as but not limited to, PPP, PPTP, or L2TP (e.g., according to FIGS. 8-10), from the peer station 704. In step 1210, the initiating station 702 then optionally decrypt the TDLS Setup Response information in the event it is encrypted. For example, the initiating station may decrypt the TDLS Setup Response information using a public key of the peer station 704.

In step 1212, the initiating station 702 next encapsulates a TDLS Setup Confirm frame within a tunneling scheme as described above, such as but not limited to, PPP, PPTP, or L2TP (e.g., according to FIGS. 8-10). Then, in step 1214, the initiating station 702 may optionally add security to the link using any one of the aforementioned security protocols. For example, the initiating station may encrypt the TDLS Setup Confirm frame using, for example, a private key. In some embodiments, encryption of the TDLS frame occurs after encapsulation by an Ethernet, IP, PPP, GRE, and/or L2TP header/trailer, thereby encrypting the entire encapsulated frame. In other embodiments, only the TDLS frame itself is encrypted. Next, in step 1216, the initiating station 702 transmits the tunnel encapsulated TDLS Setup Confirm information to the peer station 704 with the legacy AP 706 acting as an intermediary. Upon receipt of the Reply frame at the peer station 704, the TDLS link 718 is established and the stations 702, 704 may communicate directly with one another.

### Exemplary Peer Station

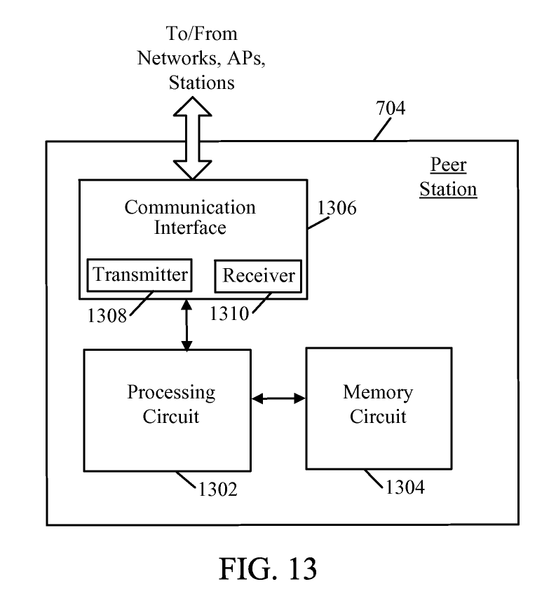

FIG. 13 illustrates a functional block diagram of a peer station 704 according to one embodiment. The peer station 704 may comprise a processing circuit 1302 (e.g., processor, processing module, etc.), a memory circuit 1304 (e.g., memory, memory modules, etc.), and a communications interface 1306. The communications interface 1306 may further comprise a transmitter 1308 and a receiver 1310.

The processing circuit 1302 is configured to process data, including TDLS frame data and perform any and all of the processing associated with preparing the TDLS frame data for transmission and reception, such as but not limited to, tunnel encapsulation and security encryption/decryption. The memory circuit 1304 is configured to store data including TDLS frame data, and encryption keys used for security schemes, such as private and public keys. The communication interface's 1306 transmitter 1308 is configured to transmit data to other network devices, such as APs and other stations. The communication interface's 1306 receiver 1310 is configured to receive data from other network devices, such as APs and other stations. Thus, the communication interface 1306 allows the peer station 704 to transmit and receive TDLS frame data along with other forms of data. The communication interface 1306 may be wireless or wired.

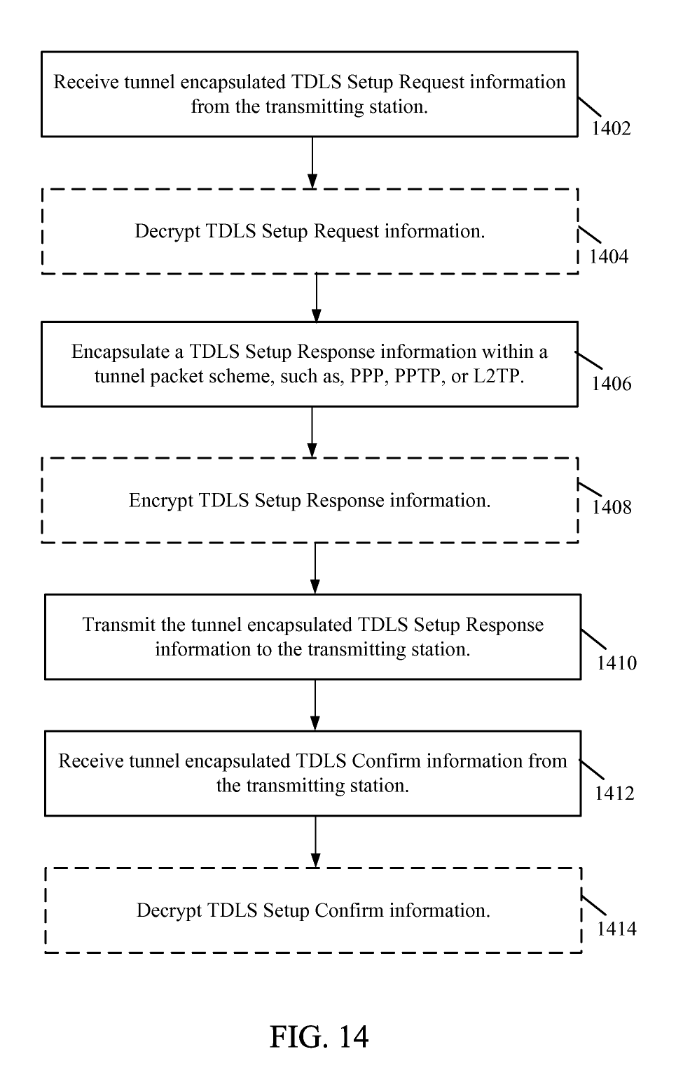

FIG. 14 shows a flowchart illustrating an exemplary method operational at the peer station 704 to establish a TDLS link with the initiating station 702 within a BSS having legacy APs. In step 1402, the peer station 704 first receives a TDLS Setup Request information encapsulated within a tunneling scheme as described above, such as but not limited to, PPP, PPTP, or L2TP e.g., according to FIGS. 8-10). In step 1404, the peer station 704 may then optionally decrypt the TDLS Setup Request information if it is encrypted. For example, the peer station 704 may decrypt the TDLS Setup Request frame using a public key of the initiating station 702.

Next, in step 1406, the peer station 704 encapsulates a TDLS Setup Response frame within a tunneling scheme as described above, such as but not limited to, PPP, PPTP, or L2TP (e.g., according to FIGS. 8-10). Then, the peer station 704 may optionally add security to the link using any one of the aforementioned security protocols. For example, in step 1408, the peer station 704 may encrypt the TDLS Setup Response frame using, for example, a private key. In some embodiments, encryption of the TDLS frame occurs after encapsulation by a Ethernet, IP, PPP, GRE, and/or L2TP header/trailer, thereby encrypting the entire encapsulated frame. In other embodiments, only the TDLS frame itself is encrypted. Next, in step 1410, the peer station 704 transmits the tunnel encapsulated TDLS Setup Response frame to the initiating station 702 with the legacy AP 706 acting as an intermediary. In step 1412, the peer station 704 then receives, from the initiating station 702, TDLS Setup Confirm information encapsulated within a tunnel scheme as described above, such as but not limited to, PPP, PPTP, or L2TP (e.g., according to FIGS. 8-10). In step 1414, the peer station 704 then optionally decrypts the TDLS Setup Confirm information in the event it is encrypted. Upon receipt of the Confirm information at the peer station 704, the TDLS link 718 is established, and the stations 702, 704 may communicate directly with one another.

One or more of the components, steps, features and/or functions illustrated in FIGS. 1, 2, 3, 4, 5, 6, 7, 8, 9, 10, 11, 12, 13, and/or 14 may be rearranged and/or combined into a single component, step, feature or function or embodied in several components, steps, or functions. Additional elements, components, steps, and/or functions may also be added without departing from the invention. The apparatus, devices, and/or components illustrated in FIGS. 2, 7, 11, and/or 13 may be configured to perform one or more of the methods, features, or steps described in FIGS. 3, 4, 5, 6, 7, 8, 9, 10, 12, and/or 14. The algorithms described herein may also be efficiently implemented in software and/or embedded in hardware.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational at a first station to initiate a Tunneled Direct Link Setup (TDLS) link within a network, comprising:
establishing a tunnel with a second station; and
establishing the TDLS link with the second station through the tunnel.

2. The method of claim 1, wherein the TDLS link is implemented within the same layer of a protocol stack as the tunnel.

3. The method of claim 1, wherein the network comprises at least one access point that serves as an intermediary for transmissions between the first station and the second station.

4. The method of claim 3, wherein the access point is adapted to block Ethernet encapsulated TDLS frame transmissions having a TDLS Ethertype between the first station and the second station.

5. The method of claim 1, wherein establishing the TDLS link through the tunnel further includes:
transmitting TDLS Setup Request information to the second station through the tunnel;
receiving TDLS Setup Response information from the second station through the tunnel; and
transmitting TDLS Setup Confirm information to the second station through the tunnel.

6. The method of claim 5, wherein the tunnel includes an encryption protocol that encrypts the TDLS Setup Request information, the TDLS Setup Response information, and the TDLS Setup Confirm information.

7. The method of claim 5, further comprising:
encrypting the TDLS Setup Request information with a private key;
decrypting the TDLS Setup Response information with a public key; and
encrypting the TDLS Setup Confirm information with the private key.

8. The method of claim 1, wherein the tunnel is established using at least one of a Point-to-Point Protocol (PPP), a Point-to-Point Tunneling Protocol (PPTP), or a Layer 2 Tunneling Protocol (L2TP).

9. The method of claim 1, wherein the tunnel is established using a Point-to-Point Protocol (PPP), and establishing the TDLS link through the tunnel further includes:
encapsulating TDLS Setup Request information within a first PPP packet prior to transmitting the TDLS Setup Request information to the second station;
receiving TDLS Setup Response information that is encapsulated within a second PPP packet from the second station; and
encapsulating TDLS Setup Confirm information within a third PPP packet prior to transmission to the second station.

10. The method of claim 1, wherein the tunnel is established using a Point-to-Point Tunneling Protocol (PPTP), and establishing the TDLS link through the tunnel further includes:
encapsulating TDLS Setup Request information within a first Point-to-Point Protocol (PPP) packet and a first General Routing Encryption (GRE) packet prior to transmitting the TDLS Setup Request information to the second station;
receiving TDLS Setup Response information that is encapsulated within a second PPP packet and a second GRE packet from the second station; and
encapsulating TDLS Setup Confirm information within a third PPP packet and a third GRE packet prior to transmission to the second station.

11. The method of claim 1, wherein the tunnel is established using L2TP, the method further comprising:
encapsulating TDLS Setup Request information within a first L2TP packet prior to transmitting the TDLS Setup Request information to the second station;
receiving TDLS Setup Response information that is encapsulated within a second L2TP packet from the second station; and
encapsulating TDLS Setup Confirm information within a third L2TP packet prior to transmission to the second station.

12. A first station for initiating a Tunneled Direct Link Setup (TDLS) link within a network, the first station comprising:
a communication interface operative to communicate over the network; and
a processing circuit coupled to the communication interface and adapted to:
establish a tunnel with a second station, and
establish the TDLS link with the second station through the tunnel.

13. The first station of claim 12, wherein the network comprises an access point that serves as an intermediary for transmissions between the first station and the second station, and the access point is adapted to block Ethernet encapsulated TDLS frame transmissions having a TDLS Ethertype between the first station and the second station.

14. The first station of claim 12, wherein establishing the TDLS link through the tunnel, the processing circuit is further adapted to:
transmit TDLS Setup Request information to the second station through the tunnel;
receive TDLS Setup Response information from the second station through the tunnel; and
transmit TDLS Setup Confirm information to the second station through the tunnel.

15. The first station of claim 14, wherein the tunnel includes an encryption protocol that encrypts the TDLS Setup Request information, the TDLS Setup Response information, and the TDLS Setup Confirm information.

16. The first station of claim 12, wherein the tunnel is established using at least one of a Point-to-Point Protocol (PPP), a Point-to-Point Tunneling Protocol (PPTP), or a Layer 2 Tunneling Protocol (L2TP).

17. The first station of claim 12, wherein the TDLS link is implemented within the same layer of a protocol stack as the tunnel.

18. A first station for initiating a Tunneled Direct Link Setup (TDLS) link within a network, the first station comprising:
means for establishing a tunnel with a second station, and
means for establishing the TDLS link with the second station through the tunnel.

19. The first station of claim 18, wherein the network includes an access point that serves as an intermediary for transmissions between the first station and the second station, and the access point is adapted to block Ethernet encapsulated TDLS frame transmissions having a TDLS Ethertype between the first station and the second station.

20. The first station of claim 18, further comprising:
means for transmitting TDLS Setup Request information to the second station through the tunnel;
means for receiving TDLS Setup Response information from the second station through the tunnel; and
means for transmitting TDLS Setup Confirm information to the second station through the tunnel.

21. The first station of claim 18, wherein the tunnel is established using at least one of a Point-to-Point Protocol (PPP), a Point-to-Point Tunneling Protocol (PPTP), or a Layer 2 Tunneling Protocol (L2TP).

22. A processor-readable medium having one or more instructions operational on a first station for initiating a Tunneled Direct Link Setup (TDLS) link, which when executed by a processor causes the processor to:
establish a tunnel with a second station, and
establish the TDLS link with the second station through the tunnel.

23. The processor-readable medium of claim 22, wherein the network includes an access point that serves as an intermediary for transmissions between the first station and the second station, and the access point is adapted to block Ethernet encapsulated TDLS frame transmissions having a TDLS Ethertype between the first station and the second station.

24. The processor-readable medium of claim 22 having one or more instructions which when executed by the processor causes the processor to further:
transmit TDLS Setup Request information to the second station through the tunnel;
receive TDLS Setup Response information from the second station through the tunnel; and
transmit TDLS Setup Confirm information to the second station through the tunnel.

25. The processor-readable medium of claim 22, wherein the tunnel is established using at least one of a Point-to-Point Protocol (PPP), a Point-to-Point Tunneling Protocol (PPTP), or a Layer 2 Tunneling Protocol (L2TP).

26. A method operational at a second station within a network for establishing a Tunneled Direct Link Setup (TDLS) link initiated by a first station, comprising:
establishing a tunnel with the first station; and
establishing the TDLS link with the first station through the tunnel.

27. The method of claim 26, wherein the TDLS link is implemented within the same layer of a protocol stack as the tunnel.

28. The method of claim 26, wherein the network includes an access point that serves as an intermediary for transmissions between the first station and the second station.

29. The method of claim 28, wherein the access point is adapted to block Ethernet encapsulated TDLS frame transmissions having a TDLS Ethertype between the first station and the second station.

30. The method of claim 26, further comprising:
receiving TDLS Setup Request information from the first station through the tunnel;
transmitting TDLS Setup Response information to the first station through the tunnel; and
receiving TDLS Setup Confirm information from the first station through the tunnel.

31. The method of claim 30, wherein the tunnel includes an encryption protocol that encrypts the TDLS Setup Request information, the TDLS Setup Response information, and the TDLS Setup Confirm information.

32. The method of claim 30, further comprising:
decrypting the TDLS Setup Request information with a private key;
encrypting the TDLS Setup Response information with a public key; and
decrypting the TDLS Setup Confirm information with the private key.

33. The method of claim 26 wherein the tunnel is established using at least one of a Point-to-Point Protocol (PPP), a Point-to-Point Tunneling Protocol (PPTP), or a Layer 2 Tunneling Protocol (L2TP).

34. The method of claim 26, wherein the tunnel is established using a Point-to-Point Protocol (PPP), and establishing the TDLS link with the first station through the tunnel includes:
receiving TDLS Setup Request information that is encapsulated within a first PPP packet from the first station;
encapsulating TDLS Setup Response information within a second PPP packet prior to transmitting the TDLS Setup Response information to the first station; and
receiving TDLS Setup Confirm information that is encapsulated within a third PPP packet from the first station.

35. The method of claim 26, wherein the tunnel is established using a Point-to-Point Tunneling Protocol (PPTP), and establishing the TDLS link with the first station through the tunnel includes:
receiving TDLS Setup Request information that is encapsulated within a first PPP packet and a first General Routing Encapsulation (GRE) packet from the first station;
encapsulating TDLS Setup Response information within a second PPP packet and a second GRE packet prior to transmitting the TDLS Setup Response information to the first station; and
receiving TDLS Setup Confirm information that is encapsulated within a third PPP packet and a third GRE packet from the first station.

36. The method of claim 26, wherein the tunnel is established using a Layer 2 Tunneling Protocol (L2TP), and establishing the TDLS link with the first station through the tunnel includes:
receiving TDLS Setup Request information that is encapsulated within a first L2TP packet from the first station;
encapsulating TDLS Setup Response information within a second L2TP packet prior to transmitting the TDLS Setup Response information to the first station; and
receiving TDLS Setup Confirm information that is encapsulated within a third L2TP packet from the first station.

37. A second station within a network for establishing a Tunneled Direct Link Setup (TDLS) link initiated by a first station, comprising:
a communication interface operative to communicate over the network;
a processing circuit coupled to the communication interface and operative to:
establish a tunnel with the first station; and
establish the TDLS link with the first station through the tunnel.

38. The second station of claim 37, wherein the network includes an access point that serves as an intermediary for transmissions between the first station and the second station, and the access point is adapted to block Ethernet encapsulated TDLS frame transmissions having a TDLS Ethertype between the first station and the second station.

39. The second station of claim 37, wherein the communication interface is further adapted to:
receive TDLS Setup Request information from the first station through the tunnel;
transmit TDLS Setup Response information to the first station through the tunnel; and
receive TDLS Setup Confirm information from the first station through the tunnel.

40. The second station of claim 39, wherein the tunnel includes an encryption protocol that encrypts the TDLS Setup Request information, the TDLS Setup Response information, and the TDLS Setup Confirm information.

41. The second station of claim 37, wherein the tunnel is established using at least one of a Point-to-Point Protocol (PPP), a Point-to-Point Tunneling Protocol (PPTP), or a Layer 2 Tunneling Protocol (L2TP).

42. The second station of claim 37, wherein the TDLS link is implemented within the same layer of a protocol stack as the tunnel.

43. A second station within a network for establishing a Tunneled Direct Link Setup (TDLS) link initiated by a first station, comprising:
means for establishing a tunnel with the first station; and
means for establishing the TDLS link with the first station through the tunnel.

44. The second station of claim 43, wherein the network includes an access point that serves as an intermediary for transmissions between the first station and the second station, and the access point is adapted to block Ethernet encapsulated TDLS frame transmissions having a TDLS Ethertype between the first station and the second station.

45. The second station of claim 43, further comprising:
means for receiving TDLS Setup Request information from the first station through the tunnel;
means for transmitting TDLS Setup Response information to the first station through the tunnel; and
means for receiving TDLS Setup Confirm information from the first station through the tunnel.

46. The second station of claim 43, wherein the tunnel is established using at least one of a Point-to-Point Protocol (PPP), a Point-to-Point Tunneling Protocol (PPTP), or a Layer 2 Tunneling Protocol (L2TP).

47. A processor-readable medium having one or more instructions operational on a second station for establishing a Tunneled Direct Link Setup (TDLS) link initiated by a first station, which when executed by a processor causes the processor to:
establish a tunnel with the first station; and
establish the TDLS link with the first station through the tunnel.

48. The processor-readable medium of claim 47, wherein the network includes an access point that serves as an intermediary for transmissions between the first station and the second station, and the access point is adapted to block Ethernet encapsulated TDLS frame transmissions having a TDLS Ethertype between the first station and the second station.

49. The processor-readable medium of claim 47 having one or more instructions which when executed by the processor causes the processor to further:
receive TDLS Setup Request information from the first station through the tunnel;
transmit TDLS Setup Response information to the first station through the tunnel; and
receive TDLS Setup Confirm information from the first station through the tunnel.

50. The processor-readable medium of claim 47, wherein the tunnel is established using at least one of a Point-to-Point Protocol (PPP), a Point-to-Point Tunneling Protocol (PPTP), or a Layer 2 Tunneling Protocol (L2TP).
